(19) United States
(12) Patent Application Publication
(10) Pub. No.: US 2007/0286571 A1
(43) Pub. Date: Dec. 13, 2007

(54) Information Recorder and Information Recording Program

(75) Inventors: Motooki Sugihara, Saitama (JP); Kyotaro Sato, Saitama (JP); Yukio Numakami, Saitama (JP); Kenichiro Tada, Saitama (JP); Koji Matsuura, Saitama (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation

(21) Appl. No.: 10/594,906

(22) PCT Filed: Mar. 11, 2005
(86) PCT No.: PCT/JP05/04310

§ 371 Date: Jun. 18, 2007

(30) Foreign Application Priority Data
Mar. 31, 2004 (JP) 2004-108241

(51) Int. Cl. H04N 5/91

(52) U.S. Cl. 386/83

(57) ABSTRACT

A recorder or the like that ensures a free space in a hard disc while recording a broadcast program in an optimum storage form according to a user's preference is provided.

The recorder or the like includes a broadcast receiver 6 to receive information on the broadcast program, a program managing unit 8 to determine a user's preference degree for the broadcast program, a reencoding unit 9 to reencode the information on the broadcast program according to the user's preference degree, and a disc drive 10 to record the reencoded information about the broadcast program on an optical disc 10a.

### TECHNICAL FIELD

The invention belongs to a technical field of an information recorder, an information recording method, an information recording program, and an information recording medium, and more specifically belongs to a technical field of an information recorder and an information recording method for receiving a broadcast program to be recorded and stored in a recording medium such as an optical disc, an information recording program used for the information recording, and an information recording medium having the information recording program recorded therein.

### BACKGROUND ART

In recent years, a recorder, including long-recording-time and high-speed-recordable recording mediums such as an HDD (Hard Disc Drive), has become popular as a recorder for receiving a broadcast program through an airwave and accumulating and recording the received broadcast program. The recorder includes the recording medium having a large capacity, allowing for recording (taping) the broadcast program and the like without concern for the remaining capacity of the recording medium, as compared with conventionally known video cassette tapes or recordable DVDs (Digital Versatile Disc).

Meanwhile, this type of recorder cannot make effective use of the large capacity if a user himself or herself selects and records the programs. Thus, a recorder has appeared, which automatically selects and records, in place of the user, programs that can interest a user.

On the other hand, in recording through the airwaves, it is currently general to digital encode, at a predetermined bit rate, an analog broadcast program before recording the broadcast program. It is considered that a method of recording a digital broadcast program as it is will become popular in the future.

However, according to the various recording methods, currently, recorded broadcast programs are often accumulated and left in the recording medium. Under this circumstance, even if the recorder includes a large-capacity recording medium, the recording capacity is exhausted in a relatively short period of time. As a result, the recorder cannot record a new broadcast program in the recording medium. Considering these problems, the user for the conventional recorder sequentially deletes the recorded broadcast programs, for example, in a chronological order of recording time by himself or herself, so as to ensure a free space for recording a new broadcast program in the recording medium. Furthermore, a recorder or the like intended to automatically ensure such a free space are disclosed in, for example, Patent Documents 1 and 2.
Patent Document 1: Japanese Patent Application Laid-Open No. H10-66018
Patent Document 2: Japanese Patent Application Laid-Open No. 2003-189243

In the recorder or the like disclosed in the Patent Document 1, a broadcast program received in an encoded state is reencoded at a plurality of different bit rates to be recorded, and pieces of data of the broadcast program recorded at the different bit rates are sequentially deleted with passage of time from a high bit rate data. This processing gradually reduces a recording capacity for recording the broadcast program, thereby ensuring a free space in the recording medium.

In the recorder or the like disclosed in the Patent Document 2, a recorded broadcast program is reencoddued at a lower bit rate after passage of predetermined time since either the program is recorded or the program is last viewed, thereby reducing a storage capacity and ensuring a free capacity in the recording medium.

### DISCLOSURE OF THE INVENTION

### Problems to be Solved by the Invention

However, the conventional recorders or the like described above have the following problems. The reencoding of all the recorded broadcast programs is uniformly performed based on elapsed time or the like since the programs are recorded. Due to this, if the user has not viewed the user's favorite broadcast program for a while since the recording date thereof for some reason, for example, the image quality of the broadcast program which the user expects to enjoy is degraded without user's recognition, as well as ordinary programs recorded at similar time to the time when the favorite broadcast program is recorded.

Furthermore, even if the user has already viewed a broadcast program, the user may often wish to continuously store the broadcast program in the recording medium with the image quality kept high and to then store the broadcast program in an optical disc such as a DVD or the like for a longer time by dubbing onto an optical disc. Even if the user so desires, the configuration of the conventional recorder or the like disadvantageously requires the user to manually protect the broadcast program by setting quality-degradation prohibition or the like to the recorder or the like.

The invention has been achieved in view of the above problems, and an exemplary object of the invention is to provide an information recorder and an information recording method for recording a broadcast program with an optimum storage form for a user set by each user, and for ensuring a free space in a recording medium, an information recording program used for information recording, and an information recording medium having the information recording program recorded therein.

### Means to Solve the Problems

To achieve the object, the invention according to claim 1 includes: an acquiring means such as a broadcast receiver for acquiring, from the outside, recorded information to be reproduced; a preference-degree setting means such as a program managing unit for setting a preference degree of a user, who reproduces the acquired recorded information, for the recorded information per recorded information; an encoding-form setting means such as a program managing unit for responding to the set preference degree to set a reencoding form of the acquired recorded information per recorded information; a reencoding means for reencoding the corresponding acquired recorded information by using the set reencoding form to generate reencoded recorded information; and an accumulating means such as an accumulation unit for accumulating the generated reencoded recorded information.

To achieve the object, the invention according to claim 8 allows a computer, included in an information recorder to acquire and record recorded information to be reproduced, to function as: an acquiring means for acquiring the recorded information from the outside; a preference-degree setting means for setting a preference degree of a user, who reproduces the acquired recorded information, for the recorded information per recorded information; an encoding-form setting means for responding to the set preference degree to set a reencoding form of the acquired recorded information per recorded information; a reencoding means for reencoding the corresponding acquired recorded information by using the set reencoding form to generate reencoded recorded information; and an accumulating means for accumulating the generated reencoded recorded information.

### BRIEF DESCRIPTION OF THE DRAWINGS

FIG. 1 is a diagram for explaining a principle of the invention;

FIG. 2 is a diagram of a schematic configuration example of an information recorder according to an embodiment;

FIG. 3 is a diagram of an internal configuration example of a knowledge database according to the embodiment;

FIG. 4 is a diagram of an example of reencoding processing according to the embodiment;

FIG. 5 is a flowchart of an example of a learning algorithm used when user's preference is learned and broadcast programs are classified according to the embodiment;

FIG. 6 is a flowchart of an example of a learning algorithm used when internal information of the knowledge database is updated according to user's viewing of the broadcast programs according to the embodiment;

FIG. 7 is a flowchart of an example of a learning algorithm used when the internal information of the knowledge database is updated based on information on storage of broadcast programs viewed by the user according to the embodiment;

FIG. 8 is a flowchart of an example of a learning algorithm used when the internal information of the knowledge database is updated based on information on deletion of broadcast programs viewed by the user according to the embodiment; and

FIG. 9 is a flowchart of processing for reencording broadcast program data by reencoding according to the embodiment.

### EXPLANATIONS OF REFERENCE NUMERALS

6 Broadcast receiver
7 Accumulation unit
7A Program-management-information recording unit
7B Knowledge database recording unit
7C Program recording unit
8 Program managing unit
9 Reencoding unit
10 Disc drive
10a Optical disc
12 Bus
R Information recorder
N Network

### BEST MODE FOR CARRYING OUT THE INVENTION

Exemplary embodiments of the invention will be explained next with reference to the drawings. In the embodiments, the invention is applied to a home-use recorder that receives a broadcast program via an airwave, recording the content of the broadcast program in a recording medium such as an HDD, and also dubbing the content of the broadcast program onto an optical disc such as a DVD.

(I) Principle of Invention

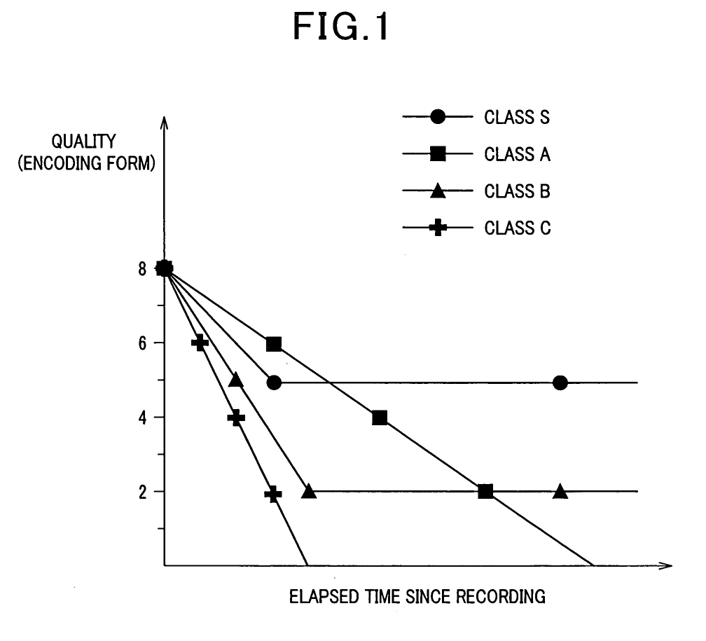

Before specifically explaining the embodiments of the invention, the principle of the invention will be explained first with reference to FIG. 1. FIG. 1 is a diagram for exemplarily illustrating a broadcast-program recording mode according to the invention.

The invention relates to reencoding processing performed by a large-capacity recorder using an HDD or the like on data (hereinafter, simply “broadcast program data”) corresponding to a broadcast program obtained by receiving an airwave from a broadcast station or the like or broadcast program data which has been previously received and already recorded.

More specifically, the invention is directed to ensure a free space in a recording medium by reflecting a user's “preference degree” in the received broadcast program data or the recorded broadcast program data, determining an encoding method used for the reencoding processing performed on the broadcast program data, reencoding the received broadcast program data by the determined encoding method, and recording the reencoded broadcast program data.

The specific meaning of “reflecting a user's preference degree” is as follows. First, a broadcast program which the user subjectively wants to record and store in a DVD or the like is stored therein for a long period of time at a predetermined quality by automatically reflecting the user's subjectivity. Second, attributes of the content of a broadcast program frequently viewed by the user are automatically determined. Furthermore, the broadcast program is stored for a long period of time with the quality of the broadcast program according to the attributes kept. Third, if broadcast programs are not so frequently viewed by the user, the broadcast programs are sequentially and automatically reencoded and deleted after passage of a predetermined period of time. By doing so, a space for reencording other broadcast programs that are important to the user is ensured in the HDD or the like without degrading the quality of the other broadcast programs.

The principle of the invention will be explained more specifically with reference to FIG. 1. FIG. 1 is a diagram for exemplarily illustrating a reencoding and deleting mode per class to be described later.

As described above, according to the invention, the user's preference degree is determined from the contents of the broadcast programs and a user's usage condition such as user's operation history. Pieces of broadcast program data to be reencorded according to the user's preference degree are classified into several hierarchies (hereinafter, “classes”), and a reencoding form is determined per class.

At the time of classification, pieces of the received broadcast program data or the like are classified into, for example, four classes of a class S, a class A, a class B, and a class C, based on the user's preference deduced by learning the attributes of broadcast programs and the user's operation history. A reencoding and deletion policy for the broadcast program data is defined per class. In parallel to the classification and definition, the broadcast programs are given priorities according to the preference degree of the user in each class.

The broadcast programs in the class S are those having attributes for which the user frequently stores the data in the DVD or the like to store the data for a long period of time. The broadcast programs in the class S correspond to those having the highest preference degree of the user. Due to this, as illustrated in FIG. 1, importance is put on the image quality of each broadcast program data in the class S at the time of recording, and the broadcast program data is stored for a long period of time with the image quality kept equal to or higher than a predetermined quality.

The broadcast programs in the class A are those (e.g., a drama) having attributes for which the user frequently views the broadcast program and for which high image quality is required. The broadcast programs in the class A correspond to those having a high preference degree of the user. Due to this, as illustrated in FIG. 1, despite need to put importance on the image quality, each of the broadcast program data is reencoded at reduced bit rates by stages according to passage of time since recording. Although the broadcast program data is recorded for a long period of time to some extent, it is finally deleted.

The broadcast programs in the class B are those (e.g., an information program for hobby, and education) having attributes for which the user frequently views but for which the image quality is not required to be so high. Namely, the broadcast programs in the class B correspond to those that are practical rather than entertaining for the user. Due to this, as illustrated in FIG. 1, the broadcast program data in the class B is reencoded so as to degrade the image quality down to a predetermined level in a short period of time. After reencoding, the image quality of the broadcast program data is kept for a long period of time. For the class B, a previous broadcast program may be replaced by a broadcast program similar in content to the previous broadcast program.

Finally, the broadcast programs in the class C correspond to those (e.g., news) having attributes for which the user does not view so frequently or for which the broadcast program is not required to be stored for a long period of time. Due to this, the broadcast program data in the class C is reencoded by stages in a short period of time and finally deleted.

A method of determining which of the classes each received broadcast program belongs includes, for example, the following three steps.

(A) Construct a group of keywords having close relations to contents of the broadcast programs previously viewed by the user and having hierarchy or association with one another into a knowledge database (hereinafter, appropriately, “knowledge DB”).

(B) Determine how program related information indicating the content or the attributes of the broadcast program to be recorded matches with each of the keywords in the knowledge database.

(C) Add or subtract a point that represents the user's preference degree to or from the keyword in the knowledge database, which keyword is determined to match with the certain recorded broadcast program, based on the user's operation history (specifically, “viewed”, “not viewed”, “recorded”, or the like) with respect to the certain recorded broadcast program.

Alternatively, the processing (C) may be replaced by the following step. The attributes of the broadcast program with which one or some of the keywords are matched are determined according to attributes set to each of the keywords in the knowledge database in advance. It is determined, based on the determination result, whether the user tends to view the broadcast program having high image quality or the broadcast program that is recorded for a long period of time.

### (II) EMBODIMENTS OF INVENTION

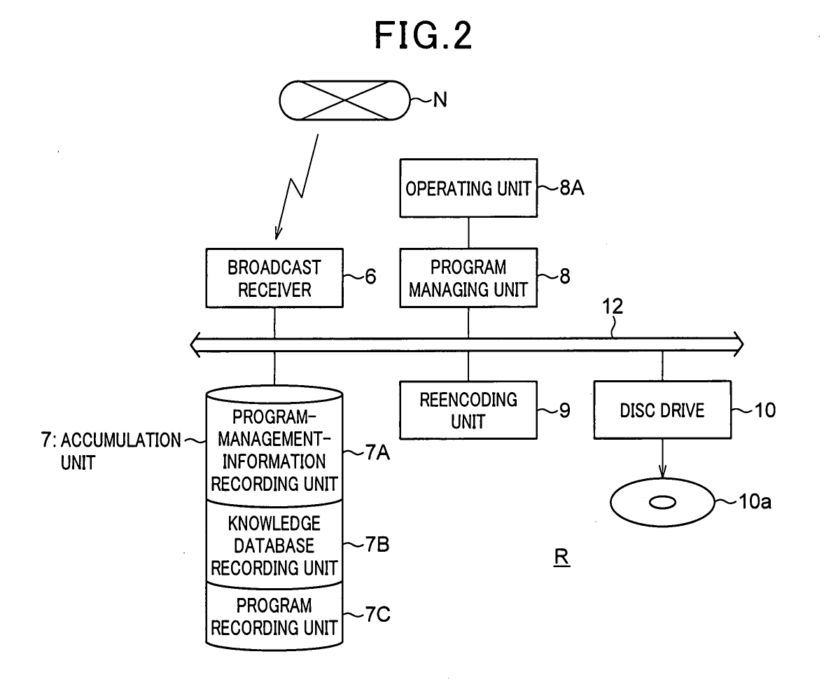

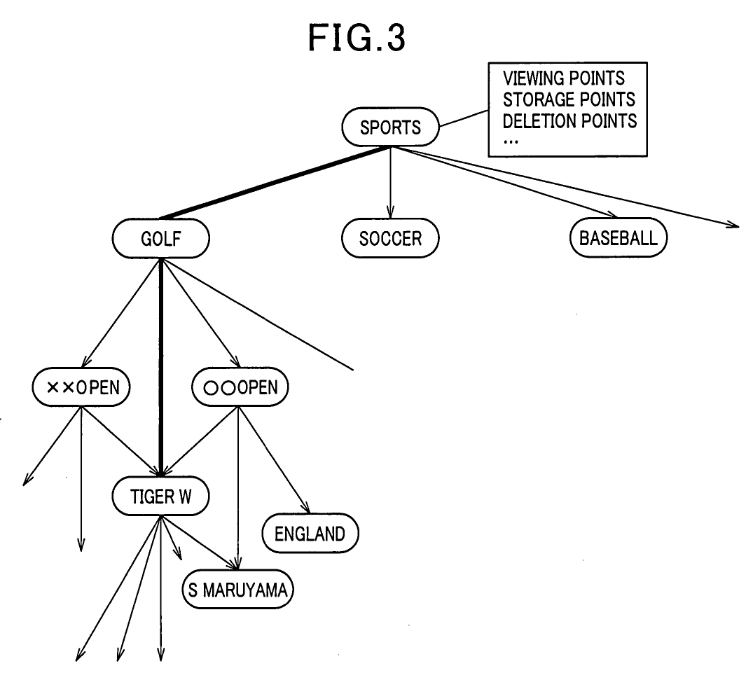

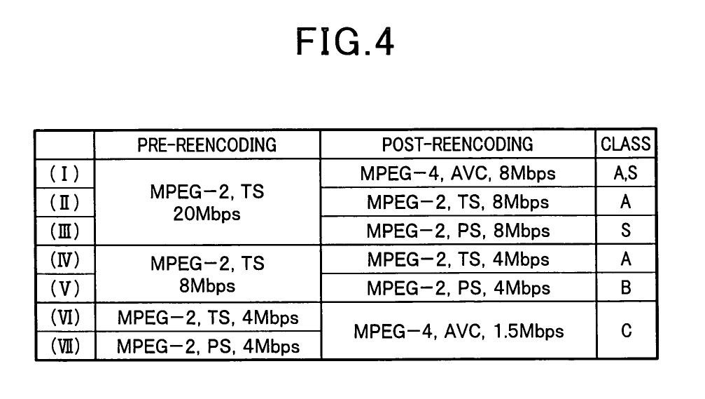

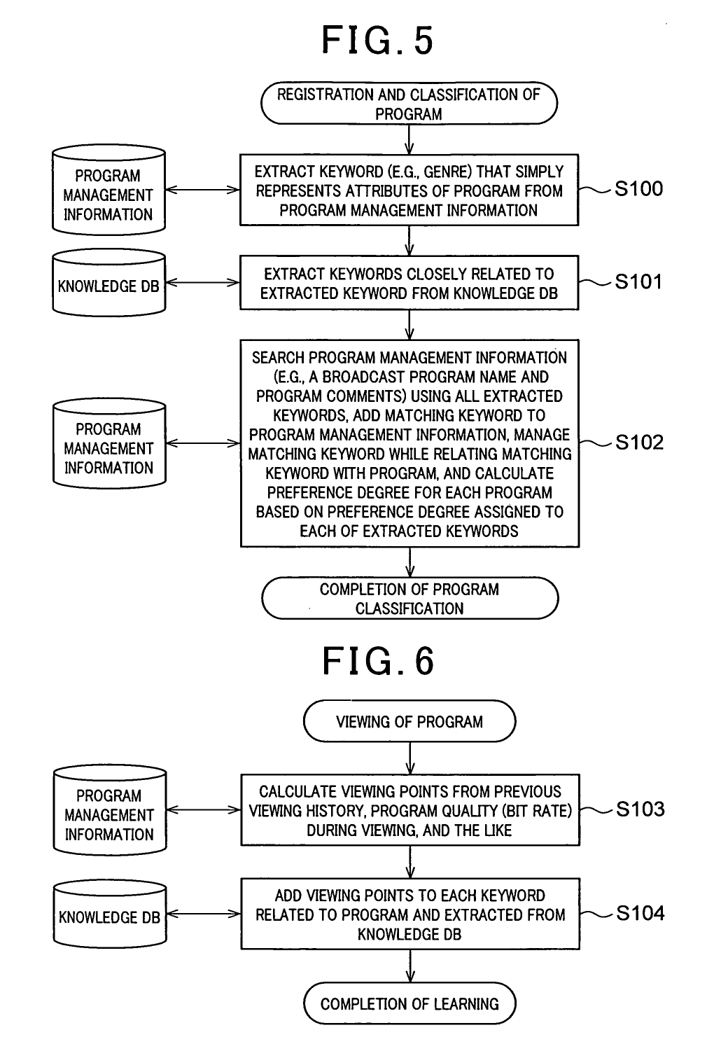

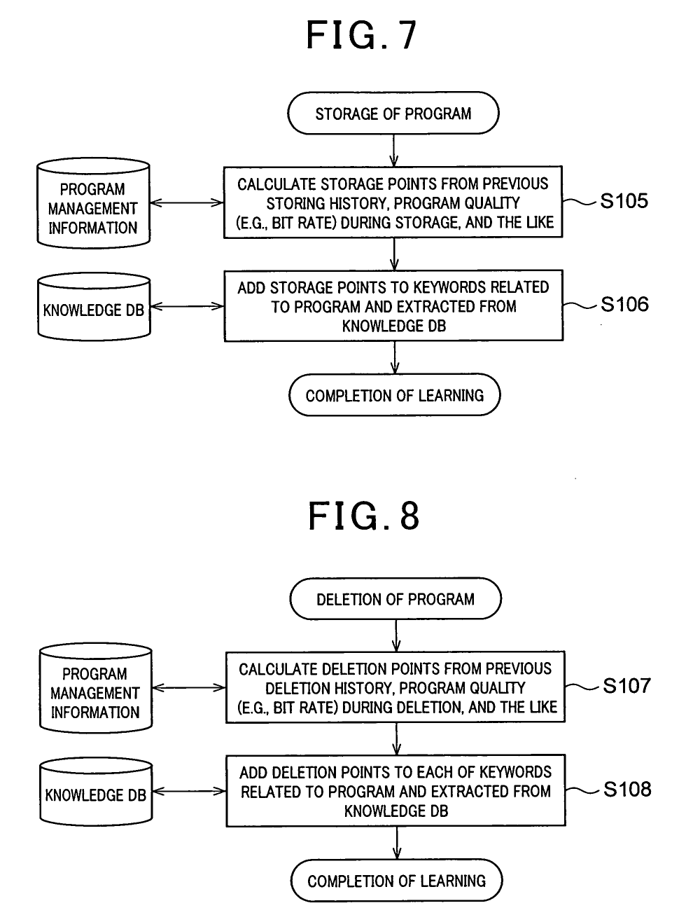

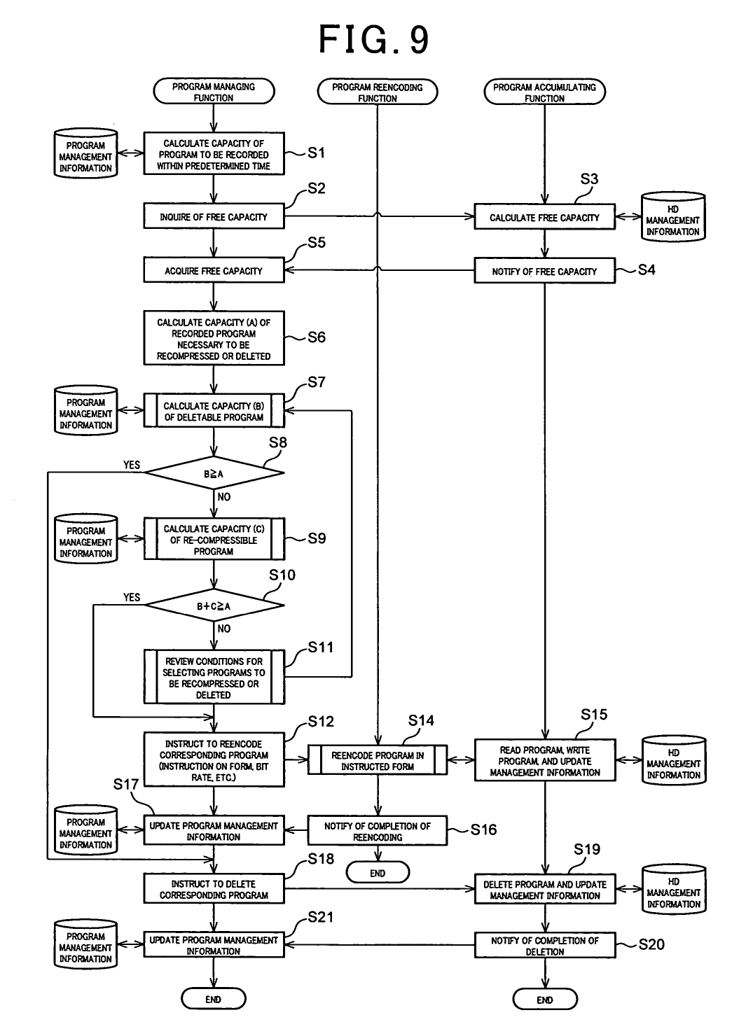

The embodiments of the invention based on the principle of the invention will be explained next with reference to FIGS. 2 to 9. FIG. 2 is a block diagram of a schematic configuration example of a recorder according to an embodiment. FIG. 3 is a diagram of an internal configuration example of the knowledge database according to the embodiment. FIG. 4 is a diagram of an example of the reencoding processing according to the embodiment. FIG. 5 is a flowchart of an example of a learning algorithm used when the user's preference is learned and the broadcast programs are classified according to the embodiment. FIG. 6 is a flowchart of an example of a learning algorithm used when internal information of the knowledge database is updated according to user's viewing of the broadcast programs according to the embodiment. FIG. 7 is a flowchart of an example of a learning algorithm used when the internal information of the knowledge database is updated based on information on storage of broadcast programs viewed by the user according to the embodiment. FIG. 8 is a flowchart of an example of a learning algorithm used when the internal information of the knowledge database is updated based on information on deletion of broadcast programs viewed by the user according to the embodiment. FIG. 9 is a flowchart of processing for recording the broadcast program data according to the embodiment.

### (A) Embodiment of Configuration of Recorder

First, a configuration of and operation performed by the recorder according to the embodiment will be explained.

As illustrated in FIG. 2, a recorder R includes a broadcast receiver 6, an accumulation unit 7, a program managing unit 8, a reencoding unit 9, and a disc drive 10. The broadcast receiver 6 receives an airwave through which information on a broadcast program transmitted from an external network N (e.g., a television broadcast network or the Internet) is carried. The accumulation unit 7, which is constituted by an HDD or the like that accumulates (records) broadcast program data corresponding to the received broadcast program, serves as an accumulating unit, a recording unit, and a reproduction-state recording unit. The program managing unit 8, to which an operating unit 8A serving as a selector is connected, manages the received broadcast program data, and serves as a preference-degree setting unit, an encoding-form setting unit, a search-word weighting unit, and a relation weighting unit. The reencoding unit 9 reads the accumulated broadcast program data from the accumulation unit 7, and reencodes the read broadcast program data. The disc drive 10 records and reproduces the broadcast program data in or from an optical disc 10a such as a DVD. The respective constituent elements of the recorder R are electrically connected to one another through a bus 12.

Furthermore, the accumulation unit 7 is constituted by a program-management-information recording unit 7A and a knowledge database recording unit 7B.

In FIG. 2, an MPEG (Moving Picture Expert Group) encoder that receives and encodes the broadcast program data, an MPEG decoder that decodes (reproduces) the encoded broadcast program data, and the like, for example, are not illustrated because they are well known.

With the above configuration, the broadcast receiver 6 includes one or a plurality of tuners. The broadcast receiver 6 receives video and audio data on the broadcast program data transmitted from a TV broadcasting station by a predetermined broadcast channel according to an instruction from the program managing unit 8, and outputs the received broadcast program data to the program managing unit 8 through the bus 12.

The broadcast receiver 6 receives not only the broadcast program data but also SI (Service Information and the like) standardized by broadcast-program related information (e.g., so-called ARIB (Association of Radio Industries and Businesses) transmitted while being multiplexed with the broadcast program data. The broadcast receiver 6 outputs the broadcast-program related information necessary to the program managing unit 8 in response to a request from the program managing unit 8.

The accumulation unit 7, which includes the HDD that accumulates the broadcast program data and the like, accumulates the broadcast program data output from the broadcast receiver 6 according to an instruction from the program managing unit 8. The accumulated broadcast program data is managed by the program managing unit 8 as one or a plurality of files. At this time, the program-management-information recording unit 7A within the accumulation unit 7 records the program management information used by the program managing unit 8 whereas the knowledge database recording unit 7B records various information constituting the knowledge database to be described later. Furthermore, a program recording unit 7C records the broadcast program data itself.

The program managing unit 8 manages program management information or the like such as a broadcasting scheduled broadcast program, a recording scheduled broadcast program, and recorded broadcast programs (accumulated in the accumulation unit 7).

Furthermore, the program managing unit 8 determines whether to reencode and delete the broadcast program data based on the program management information according to the state (free capacity or the like) of the program recording unit 7C. Furthermore, the program managing unit 8 controls the reencoding unit 9 to reencode the recorded broadcast program determined to be reencoded, controls the reencoding unit 9 to delete the recorded broadcast program determined to be deleted, or controls to record the reencoded broadcast program data in the optical disc 10a.

The configuration of the knowledge database recorded in the knowledge database recording unit 7B under control of the program managing unit 8 will be explained next with reference to FIG. 3. FIG. 3 illustrates the knowledge database related to sports by way of example.

The knowledge database according to the embodiment accumulates predetermined keywords extracted based on information such as a user's viewing state while associating the keywords with one another. Further, the knowledge database includes a learning function of adding a predetermined keyword extracted based on user's present or future viewing to the knowledge database.

Examples of the keywords include genres, types, and names. Namely, as exemplarily illustrated in FIG. 3, if the broadcast program viewed by the user is ∞ Open Championship, the extracted keywords correspond to “sports” that is a genre as a most superordinate concept, “golf” that is a type as a subordinate concept of the “sports”, “∞ Open” that is a subordinate concept of the “golf”, “Tiger W” that is the name of a competitor as a subordinate concept of the ∞ Open, “United States” that is the name of the country as a venue, and the like. As illustrated in FIG. 3, the extracted keywords are classified into predetermined hierarchies based on information on the respective broadcast program while being associated with one another in the knowledge database. By so classifying, the keywords have more meshed relations as they are in lower layers in the knowledge database.

Furthermore, if the user views similar broadcast programs a number of times according to the user's viewing state, relation points serving as indices representing how closely the keywords are related to one another are added to respective links among the keywords. In FIG. 3, the magnitude of the relation points is expressed by the thickness of a line.

On the other hand, if the user is to view, store, or delete a broadcast program, preference points are added to keywords extracted at that time as determination standard for the user's preference. More specifically, in case of viewing, storing, and deletion, the extracted keywords are given, for example, “+1” as the user's preference point for viewing, “+2” as that for storing, and “−1” as that for deletion, respectively.

The preference point may be input and set directly by the user from the operating unit 8A per broadcast program.

This hierarchical structure (tree structure) of the knowledge database allows for extracting keywords matched to a broadcast program viewed by the user by determining the degree of matching between the keywords extracted based on information on the broadcast program and the keywords stored in the knowledge database, adding or subtracting preference points to or from the extracted keywords, and calculating the user's preference points. The preference points indicate the user's preference degree for the broadcast program information according to the embodiment.

In the knowledge database, predetermined keywords are extracted from the program management information on the broadcast program viewed by the user, and the keywords are accumulated while being related to one another. Besides, the keywords are additionally accumulated based on program management information on viewing or the like of a new broadcast program in the knowledge database while reflecting the newly added keywords in the previous information.

In this manner, the knowledge database itself accumulates the information on the user's viewing state and the like and includes the learning function. This knowledge database allows for grasping what kind of broadcast programs the user often views and what kind of broadcast programs the user stores or deletes.

The reencoding unit 9 includes encoding and combining functions corresponding to several encoding forms (compression methods, multiplexing forms, bit rates, or the like). In response to an instruction from the program managing unit 8, the reencoding unit 9 reencodes the encoding form of the recorded broadcast program data accumulated in the recording medium of the accumulation unit 7 by the designated encoding form.

FIG. 4 illustrates an example of the reencoding processing.

As illustrated in FIG. 4, an example of the reencoding processing includes conversion of the compression form and the bit rate as indicated by (I), (VI), and (VII), conversion of only the bit rate as indicated by (II), (IV), and (V), and conversion of the multiplexing form and the bit rate as indicated by (III). Alternatively, the image resolution may be converted at the time of the reencoding processing.

At this time, as an example of the relationship between the reencoding forms and the respective classes, it is assumed that (I) in FIG. 4 corresponds to the class A or S, (II) and (IV) in FIG. 4 correspond to the class A, (III) in FIG. 4 corresponds to the class S, (V) in FIG. 4 corresponds to the class B, and (VI) and (VII) in FIG. 4 correspond to the class C.

### (B) Embodiment of Learning Algorithm

Next, an example of a learning algorithm used when the user's preference is learned to perform classification or the like of the broadcast programs according to the embodiment will be explained with reference to FIGS. 5 to 8.

Processing for classifying the received broadcast programs will be explained first with reference to FIG. 5. FIG. 5 is an example of the learning algorithm used when the program managing unit 8 learns the user's preference and classifies the broadcast programs. The classification is performed when, for example, the user reserves recording or records broadcast programs.

As illustrated in FIG. 5, in the classification processing, the program managing unit 8 extracts a keyword (e.g., genre) that simply represents attributes of each broadcast program viewed by the user from the program management information (step S100).

The program managing unit 8 extracts keywords closely related to the extracted keyword from the knowledge database (step S101). Finally, the program managing unit 8 searches the program management information (e.g., a broadcast program name, and broadcast program comments) using all the keywords extracted from the knowledge database, adding a matching keyword to the program management information, and managing the matching keyword while relating the keyword with the broadcast program data. Furthermore, the program managing unit 8 calculates preference points assigned to each of the keywords extracted from the knowledge database, calculating the user's preference degree, and classifying the broadcast program based on the calculation result (step S102). At this time, the program managing unit 8 manages information for classification while relating the broadcast program data to the program management information.

This classification processing allows the broadcast program data recorded by the user to be classified into the class according to the user's preference degree.

Examples of learning processing performed according to user's usage condition (viewing, storing, and deletion of the broadcast program) will be explained next with reference to FIGS. 6 to 8, respectively.

The learning processing according to user's viewing of the broadcast program will be explained first with reference to FIG. 6. FIG. 6 is an example of a learning algorithm used when the program managing unit 8 updates information in the knowledge database based on user's viewing of the broadcast program. The learning algorithm is intended to reflect information on the broadcast program viewed by the user in the knowledge database.

As illustrated in FIG. 6, in the learning algorithm, the program managing unit 8 first extracts the previous viewing history and the quality (e.g., bit rate) of the broadcast program during viewing from the program management information on the broadcast program viewed by the user, and calculates viewing points (step S103). The viewing points are assigned if the user has previously viewed a similar broadcast program or recorded the broadcast program with high quality.

The program managing unit 8 then extracts a keyword or the like that simply represents the broadcast program or the like from the program management information on the broadcast program, extracting keywords related to the keyword, which is extracted from the program management information, from the knowledge database, adding viewing points to each of the keywords extracted from the knowledge database, and updating the knowledge database (step S104).

Thus assigning the viewing points to each of the keywords related to the broadcast program viewed by the user according to the user's viewing state provides a criterion to determine the user's preference state based on the viewing points for the following reason. If the user has previously viewed the similar broadcast program or recorded the broadcast program with high quality, the user's preference degree for the broadcast program is determined to be high.

The learning processing according to storage of the broadcast program by the user will be explained next with reference to FIG. 7. FIG. 7 is an example of a learning algorithm used when the program managing unit updates the information in the knowledge database based on information on storage of the broadcast program viewed by the user. The learning algorithm is intended to reflect the information on storage of the broadcast program viewed by the user in the knowledge database.

As illustrated in FIG. 7, in the learning algorithm, the program managing unit 8 first extracts the previous storing history and the quality (e.g., bit rate) of the broadcast program during storage from the program management information on the broadcast program viewed by the user, thus calculating storage points (step S105).

The storage points are assigned when, for example, the user has previously viewed and stored a similar broadcast program.

The program managing unit 8 then extracts a keyword or the like that simply represents the broadcast program or the like from the program management information on the broadcast program, extracting keywords related to the keyword, which is extracted from the program management information, from the knowledge database, adding the storage points to each of the keywords extracted from the knowledge database, and thus updating the knowledge database (step S106).

This assigning the storage points to each of the keywords related to the broadcast program according to the storage state of the broadcast program previously viewed by the user allows the user's preference state to be determined based on the storage points for the following reason. If the user has previously viewed and stored the similar broadcast program, the user's preference degree for the broadcast program is determined to be high.

It is to be noted that the number of storage points may be set in view of the storage state (e.g., correspondence to the class S).

Finally, the learning processing according to user's deletion of the broadcast program will be explained with reference to FIG. 8. FIG. 8 is an example of a learning algorithm used when the program managing unit 8 updates the information in the knowledge database based on information on deletion of the broadcast program viewed by the user. The learning algorithm is intended to reflect the deletion information on the broadcast program viewed by the user in the knowledge database.

As illustrated in FIG. 8, in the learning algorithm, the program managing unit 8 first extracts a previous deletion history and the quality (e.g., bit rate) of the broadcast program at the deletion time from the program management information on the broadcast program viewed by the user, thus calculating deletion points (step S107).

The deletion points are assigned, for example, if the user has previously viewed and deleted a similar broadcast program.

The program managing unit 8 then extracts a keyword or the like that simply represents the broadcast program or the like from the program management information on the broadcast program, extracting keywords related to the keyword, which is extracted from the program management information, from the knowledge database, adding the deletion points to each of the keywords extracted from the knowledge database, and thus updating the knowledge database (step S108).

This assigning the deletion points (minus points) to each of the keywords related to the broadcast program according to the deletion state of the broadcast program previously viewed by the user allows the user's preference state to be determined based on the deletion points for the following reason. If the user has previously viewed and deleted the similar broadcast program, the user's preference degree for the broadcast program is determined to be low.

It is to be noted that the number of deletion points may be set in view of the deletion state (e.g., whether the broadcast program corresponds to the class A or the class C)

### (C) Embodiment of Reencoding Processing

An operation for the reencoding processing performed by the recorder R according to the embodiment will finally be explained with reference to FIG. 9. FIG. 9 is an operation sequence used when the broadcast program data is reencoded and recorded. FIG. 9 illustrates, for example, an operation performed when the user makes a recording reservation.

As illustrated in FIG. 9, in the reencoding processing according to the embodiment, the program managing unit 8 first calculates the capacity of broadcast program data to be recorded up to reservation time based on the program management information on the broadcast program data for which the user makes a recording reservation (step S1). The program managing unit 8 then inquires the accumulation unit 7 of a free capacity (step S2).

In response to the inquiry from the program managing unit 8, the accumulation unit 7 calculates the free capacity of the program recording unit 7C described in HD management information separately stored in the accumulation unit 7 (step S3), and notifies the program managing unit 8 of the calculated free capacity (step S4).

The program managing unit 8 acquires information on the free capacity by notification from the accumulating unit 7 (step S5), and determines whether there is a broadcast program necessary to be reencoded or deleted with respect to the broadcast program data recorded in the accumulation unit 7. If the determination result is affirmative, the program managing unit 8 calculates a capacity “A” of the broadcast program data necessary to be reencoded or deleted (step S6). After calculating the capacity “A”, the program managing unit 8 calculates the capacity of deletable or reencodable program data that satisfies the condition of the capacity “A”.

If the deletable broadcast program data is present, the program managing unit 8 calculates the capacity of the deletable broadcast program data based on the program management information on the broadcast program data (step S7). The calculated capacity is represented by a deletable capacity “B”.

The program managing unit 8 then compares the deletable capacity “B” with the necessary capacity “A”, and determines whether the capacity “B” is equal to or larger than the capacity “A” (step S8). If the capacity “B” is equal to or larger than the capacity “A” (step S8; Y), the program managing unit 8 instructs the accumulation unit 7 to delete the broadcast program data (step S18). The accumulation unit 7 deletes the broadcast program data based on the instruction and updates the HD management information (step S19). Furthermore, after deleting the broadcast program data, the accumulation unit 7 notifies the program managing unit 8 that the deletion of the broadcast program data is completed (step S20). The program managing unit 8 updates the program management information based on the notification (step S21), and a series of processing are finished.

In this manner, if the user makes the recording reservation or the like, then the capacity of the broadcast program data to be recorded is calculated, and the free capacity in the program recording unit 7C is calculated. Furthermore, the capacity “A” of the recorded broadcast program data necessary to be reencoded or deleted is calculated, and the capacity “A” is compared with the capacity “B” of the deletable broadcast program data. If the capacity “B” of the deletable broadcast program data is larger than the capacity “A”, then the deletable broadcast program data is deleted, and the processing is finished. This processing ensures a free capacity in the program recording unit 7C, allowing for accumulating new broadcast programs in the program recording unit 7C.

On the other hand, if it is determined at step S8 that the capacity “B” is smaller than the capacity “A” (step S8; N), the program managing unit 8 calculates the capacity of a re-compressible broadcast program based on the program management information in the program-management-information recording unit 7A (step S9). The calculated capacity is represented by a reencodable capacity “C”.

A sum of the capacity “B” and the capacity “C” is compared with the capacity “A”, and it is determined whether the sum of the capacity “B” and the capacity “C” is equal to or larger than the capacity “A” (step S10). If the sum of the capacity “B” and the capacity “C” is equal to or larger than the capacity “A” (step S10; Y), the program managing unit 8 instructs the reencoding unit 9 to reencode the corresponding broadcast program data (instruction on the reencoding form, the bit rate, and the like) (step S12).

The reencoding unit 9 reads the broadcast program data from the accumulation unit 7 while referring to the HD management information in the accumulation unit 7, and reencodes the broadcast program data in the instructed form (step S14). The broadcast program data that has been reencoded is re-recorded in the HD management information in the accumulation unit 7, thereby updating the HD management information (step S15).

After the reencoding processing, the reencoding unit 9 notifies the program managing unit 8 that the reencoding processing is completed (step S16). The program managing unit 8 updates the program management information (step S17) and the process proceeds to step S18. In the processing at step S18, if it is determined, as a result of the processing at step S6, that the deletable broadcast program data is present, then the program managing unit 8 instructs the accumulation unit 7 to delete the broadcast program data, and the process proceeds to step S19.

In this manner, if the capacity “B” of the deletable broadcast program data is smaller than the capacity “A” of the reencodable or deletable broadcast program data, the reencodable broadcast program data is reencoded in the predetermined form. If the deletable broadcast program data is present, the deletable broadcast program data is deleted. This processing ensures a free capacity in the program recording unit 7C, allowing for accumulating a new broadcast program in the program recording unit 7C. Furthermore, the reencoding form is determined according to reencoding and deletion policy (rule) to be applied to each of the broadcast program classes classified according to the user's preference as illustrated in, for example, FIG. 1.

If it is determined at step S10 that the sum of the capacity “B” and the capacity “C” is smaller than the capacity “A” (step S10; N), then the program managing unit 8 reviews conditions for selecting the broadcast program information to be deleted or recompressed (step S11), and the process returns to step S7. The review of the selecting conditions means processing for temporarily reducing a period of the reencoding processing performed step by step or the like.

This processing ensures a free capacity in the program recording unit 7C, allowing for accumulating a new broadcast program in the program recording unit 7C.

An example of specific processing methods used when the broadcast program data is actually reencoded includes so-called sequential reencoding processing, initial simultaneous encoding processing, and hierarchical encoding processing.

The sequential reencoding processing is a method of compressing the broadcast program while the broadcast program data recorded in the program recording unit 7C is reencoded step by step as required.

The initial simultaneous encoding processing is a method of reencoding the broadcast program in a plurality of forms assumed during the initial recording in advance, and sequentially deleting pieces of reencoded data in descending order of quality when it is later necessary to perform reencoding.

The hierarchical encoding processing is a method of encoding the broadcast program in a predetermined form using hierarchical encoding technique during initial recording, and deleting the encoded data in descending order of layers if it is later necessary to perform reencoding.

As described above, according to the operation performed by the recorder R according to the embodiment, the broadcast program data is reencoded according to the user's preference degree. Therefore, the broadcast programs is reencoded in ascending order of user's necessity, and the capacity of the recording medium for newly recording a broadcast program is ensured without degrading the quality of the broadcast program that is important to the user.

If it is configured such that the user determines the user's preference degree by selecting one preference degree from among at least one option, the user decides the form for the reencoding processing by himself or herself. Therefore, this processing allows for keeping the broadcast program that is important to the user without degrading its quality, with keeping or deleting the broadcast program the user's necessity of which is low by reencoding of the broadcast program in the predetermined form or the like.

Further, if it is configured such that the user's preference degree is determined based on a learning function of deriving the user's preference from the user's past usage condition, a reencoding processing form is determined based on the user's past usage condition. Therefore, this processing allows for keeping the broadcast program that is important to the user without degrading its quality, with keeping or deleting the broadcast program the user's necessity of which is low by reencoding of the broadcast program in the predetermined form or the like, while reflecting the user's preference.

Furthermore, the broadcast program which, for example, the user wants to store in a DVD or the like is automatically reencoded up to the quality of the broadcast program with which the broadcast program is left and is not reencoded furthermore by the learning of the user's preference. This processing allows for integrally storing the broadcast programs in the DVD at high speed with a desired quality after accumulating the broadcast programs in the program recording unit 7C to some extent.

Furthermore, as for each of user's favorite broadcast programs, for example, the attributes (users' demand to view the program with as high quality as possible, to view the program repeatedly without regard to quality, or the like) of the broadcast program is determined, thus keeping the broadcast program with the quality according to the attributes of the broadcast program.

Furthermore, the reencoding processing is performed using the encoding form including at least one of the compression form, the bit rate, and the multiplexing form according to the user's preference degree. This processing allows for recording each broadcast program while reflecting the user's preference.

In the above configuration, the program managing unit 8 may delete the broadcast program data recorded according to the user's preference degree.

This processing allows unnecessary broadcast programs for the user to be deleted, thus ensuring the capacity of the program recording unit 7C for newly recording a broadcast program.

Furthermore, a program corresponding to the flowcharts illustrated in FIGS. 5 to 9 may be recorded in an information recording medium such as a flexible disc or a hard disc, or may be acquired through a network such as the Internet, and executed by a general-purpose CPU, whereby the general-purpose CPU may function as the program managing unit 8.

1. An information recorder comprising:
an acquiring means for acquiring, from the outside, a recorded information to be reproduced;
a viewing means for viewing the acquired recorded information;
a knowledge database for extracting keywords related to the viewed recorded information to accumulate and store the keywords;
a preference-degree setting means for setting a preference degree of a user for the recorded information per recorded information by comparing the keywords stored in the knowledge database with a keyword related to the recorded information to be reproduced;
an encoding-form setting means for responding to the set preference degree to set a reencoding form or deletion form for the acquired recorded information per recorded information;
a reencoding means for reencoding the corresponding acquired recorded information by using the set reencoding form to generate reencoded recorded information;
an accumulating means for accumulating the generated reencoded recorded information;
a deleting means for deleting the corresponding recorded information accumulated in the accumulating means by using the set deletion form; and
a knowledge-database updating means for updating preference points assigned to the keywords stored in the knowledge database,
wherein the preference-degree setting means determines degree of matching between the keywords stored in the knowledge database and the keyword related to the recorded information to be reproduced to extract a matched keyword, thus setting the preference degree by adding or subtracting a preference point set to the extracted keyword.

2. The information recorder according to claim 1,
wherein the knowledge-database updating means for responding to viewing, storage and deletion of recorded information corresponding to a keyword to be updated to change a preference point related to the keyword.

3. (canceled)

4. The information recorder according to claim 1, wherein the
preference-degree setting means further comprising:
a selecting means used by the user to select a preference degree from a plurality of preference degrees for the recorded information; and
a recording means for recording the selected preference degree per recorded information.

5. The information recorder according to claim 1, wherein
the preference-degree setting means includes:
a reproduction-state recording means for accumulating and recording a previous reproduction state of the user of each of the recorded information: and
a setting means for setting the preference degree per recorded information based on the accumulated and recorded reproduction state.

6-7. (canceled)

8. An information recording program allowing a computer, included in an information recorder to acquire and record recorded information to be reproduced, to function as:
an acquiring means for acquiring the recorded information from the outside;
a viewing means for viewing the acquired recorded information;
a preference-degree setting means for setting a preference degree of a user for the recorded information per recorded information by using a knowledge database for extracting keywords related to the viewed recorded information to accumulate and store the keywords and by comparing the keywords stored in the knowledge database with a keyword related to the recorded information to be reproduced, and for determining degree of matching between the keywords stored in the knowledge database and the keyword related to the recorded information to be reproduced to extract a matched keyword, thus setting the preference degree by adding or subtracting a preference point set to the extracted keyword;
an encoding-form setting means for responding to the set preference degree to set a reencoding form or deletion form of the acquired recorded information per recorded information;
a reencoding means for reencoding the corresponding acquired recorded information by using the set reencoding form to generate reencoded recorded information;
an accumulating means for accumulating the generated reencoded recorded information;
a deleting means for deleting the corresponding recorded information accumulated in the accumulating means by using the set deletion form; and
a knowledge-database updating means for updating preference points assigned to the keywords stored in the knowledge database.

9. The information recording program according to claim 8,
wherein the knowledge-database updating means responds to viewing, storage and deletion of recorded information corresponding to a keyword to be updated to change a preference point related to the keyword.
